(19) United States
(12) Patent Application Publication
(10) Pub. No.: US 2013/0010294 A1
(43) Pub. Date: Jan. 10, 2013

(54) OPTICAL MEASUREMENT ANALYSIS DEVICE, STORAGE ROOM, ELECTROMAGNETIC-WAVE GENERATING DEVICE, AND OPTICAL MEASUREMENT ANALYSIS METHOD

(75) Inventors: Kyoko MATSUDA, Osaka-shi (JP); Toshiyuki Okumura, Osaka-shi (JP)

(73) Assignee: SHARP KABUSHIKI KAISHA, Osaka (JP)

(21) Appl. No.: 13/531,140

(22) Filed: Jun. 22, 2012

(30) Foreign Application Priority Data
Jul. 7, 2011 (JP) 2011-150644

(51) Int. Cl. G01J 3/28

(52) U.S. Cl. 356/326

(57) ABSTRACT

There is provided an optical measurement analysis device capable of applying light to substantially the entire surface of a to-be-analyzed object for improving the analysis accuracy. The optical measurement analysis device according to the present embodiment includes a container, a light source, a light irradiation unit, a light reception unit, a spectroscope unit, and an analyzing unit for analyzing an optical spectrum obtained by the spectroscope unit. The container has an inner wall adapted to reflect light reflected by the to-be-analyzed object and light transmitted therethrough.

This nonprovisional application is based on Japanese Patent Application No. 2011-150644 filed on Jul. 7, 2011 with the Japan Patent Office, the entire contents of which are hereby incorporated by reference.

### BACKGROUND OF THE INVENTION

1. Field of the Invention

The present invention relates to optical measurement analysis devices, optical measurement analysis methods, and storage rooms and electromagnetic-wave generating devices which have cooling functions and include optical measurement analysis devices as components.

2. Description of the Background Art

Conventionally, as analyzing methods for analyzing to-be-inspected objects in nondestructive manners, there have been methods which apply light to to-be-inspected objects and further analyze optical spectra of transmitted light or reflected light resulted therefrom for acquiring information about properties thereof through analyzing methodologies such as multivariate analyses. Such analyzing methods utilize the principle that a substance causes changes in light having a certain wavelength, such as absorption, scattering and reflection thereof. More specifically, these analyzing methods utilize the fact that properties of light, such as the wavelengths of light which are changed by a substance, the absorbance and the reflectivity for light in such cases, are related to properties of the substance, such as components of the substance, grain sizes of the substance, the concentrations of components therein, and types of contained impurities. The absorbance and the reflectivity can be determined by applying simple calculation formulas to spectra of transmitted light or reflected light. Accordingly, by analyzing the absorbance or the reflectivity for light which have been resulted from applying light to a to-be-inspected object, it is possible to acquire information about properties of the to-be-inspected object.

There have been suggested various types of devices for performing optical measurement analyses as described above. For example, FIG. 9 illustrates an optical measurement device disclosed in Japanese Patent Laying-Open No. 2001-133401. The optical measurement device includes a projector 904 for projecting light to to-be-measured objects H such as fruits, and a light receiver 905 for receiving light passed through to-be-measured objects H. The optical measurement device is adapted to determine conditions of to-be-measured objects H, based on the intensity of light received by light receiver 905. Projector 904 and light receiver 905 are provided such that an optical axis J1 of projector 904 intersects with an optical axis J2 of light receiver 905 at an approximate center of a conveyer 910 in a widthwise direction. The optical measurement device is adapted such that, when no to-be-measured object exists on both the optical axes, light with lower intensity is injected to light receiver 905 from projector 904, for reducing the number of neutral density filters provided in the light receiver as much as possible, since the optical axis of projector 904 is not coincident with the optical axis of light receiver 905. Further, side walls 909 are provided with openings for allowing optical beams to pass therethrough, at their portions facing projector 904 and light receiver 905. A low-reflection plate 908 is mounted on the side wall closer to light receiver 905 over its portion which is irradiated with light from projector 904, except the aforementioned opening. Low-reflection plate 908 is for preventing light reflected by side walls 909 from entering the light receiver. Namely, the optical measurement device disclosed in Japanese Patent Laying-Open No. 2001-133401 is adapted to determine conditions of to-be-measured objects H, by receiving only light passed through to-be-measured objects H with light receiver 905, and by defining, as a reference value, a value obtained when there is no to-be-measured object H therein.

FIG. 10 illustrates a calorie-content measurement device disclosed in Japanese Patent Laying-Open No. 2005-292128, as another example. The calorie-content measurement device includes an object holder 1001 including a table for placing a to-be-inspected object M thereon, a light source unit 1020 for applying light in the near-infrared range to to-be-inspected object M placed on the table, a light receiver 1030 for receiving reflected light or transmitted light from object M, and a controller 1040 for calculating the caloric content of the object based on the absorbance of light received by light receiver 1030. The calorie-content measurement device is adapted to preliminarily apply near-infrared light to a sample object having a known calorie content, and to preliminarily calculate a regression formula, through calculations according to a multiple regression analysis for a second derivative spectrum of the absorbance of light reflected or passed through the sample object. The calorie-content measurement device is adapted to calculate the calorie content of object M, with controller 1040, using the calculated regression formula, from the absorbance of light received by light receiver 1030. Japanese Patent Laying-Open No. 2005-292128 also discloses the fact that the calorie-content measurement device can perform multi-point measurement, by rotating a rotational table 1002 on which an object M is placed, through a combination of driving by an X-axis motor 1007 and driving by a rotational motor 1003.

In order to perform optical measurement analyses with excellent accuracy, it is desirable to apply light to the entire surface of a to-be-inspected object for acquiring an optical spectrum therefrom. This is because, in many cases, such a to-be-inspected object has non-uniform distributions of components contained therein, the concentrations thereof, impurities contained therein and the like, which may induce variations in results of analyses depending on its portion irradiated with light. For example, in a case where the to-be-inspected object is a crop, it has non-uniform distributions of components contained therein and the concentrations thereof, in general. Further, when an object is enveloped by a packaging material such as a wrap or a film, such a packaging material does not always have a uniform thickness. Further, in a case where the to-be-inspected object is a food stuff, and it is desired to check whether or not molds, microorganisms or the like have occurred therein, it is impossible to perform inspections with higher accuracy by performing analyses at only certain portions, since they can occur at uneven positions.

The optical measurement device disclosed in Japanese Patent Laying-Open No. 2001-133401 is adapted to perform analyses based on transmitted light, which has induced the problem that to-be-measured objects are limited to those which can be measured through transmitted light. Further, light is transmitted through only a portion of the to-be-measured object, so that the resultant information reflects only the portion of the to-be-measured object. When irradiation light is made to have significantly-increased intensity, in order to obtain a spectrum of light transmitted through the entire surface of the to-be-measured object, heat inducted thereby may deteriorate the to-be-measured object.

The calorie-content measurement device disclosed in Japanese Patent Laying-Open No. 2005-292128 is adapted to increase the number of measurement points, by rotating the table on which the object is placed. This results in an increase of the measurement time period and, furthermore, necessitates a space or parts for forming a rotating mechanism therefor. Further, since light is applied to the to-be-measured object from the light source provided on the upper surface of the device, the to-be-measured object is irradiated with the light only at its upper surface, which has made it impossible to perform measurement on the entire object.

Further, in general, reflected light contains regularly-reflected components and diffused/reflected components. With the calorie-content measurement device disclosed in Japanese Patent Laying-Open No. 2005-292128, regularly-reflected components from an object M can be efficiently received, but diffused/reflected light can not reach the light receiver or can be significantly attenuated every time it is reflected and, as a result thereof, such diffused/reflected light can not be easily detected. Accordingly, information included in such diffused/reflected light tends to be lost, which has induced the problem of poor analysis accuracy.

### SUMMARY OF THE INVENTION

The present invention was made in view of the aforementioned problems and aims at providing an optical measurement analysis method and an optical measurement analysis device which are capable of efficiently applying light to the entire surface of a to-be-analyzed object if possible and, further, efficiently receiving light reflected by or transmitted through the to-be-analyzed object, thereby performing analyses with improved accuracy.

In accordance with one aspect, an optical measurement analysis device includes: a container capable of housing a to-be-analyzed object; a light source; a light irradiation unit adapted to direct light from the light source into the container; a light reception unit adapted to receive transmitted light having been transmitted through the to-be-analyzed object or reflected light having been reflected by the to-be-analyzed object; a spectroscope unit adapted to disperse light received by the light reception unit into a spectrum; and an analyzing unit adapted to analyze an optical spectrum obtained by the spectroscope unit. The container has an inner wall adapted to reflect the transmitted light or the reflected light.

Preferably, the optical measurement analysis device includes a measurement table for placing the to-be-analyzed object thereon. The measurement table is structured to have an area smaller than that of the to-be-analyzed object.

Preferably, the measurement table includes a sensor for detecting the weight of the to-be-analyzed object.

Preferably, the light source and the light reception unit are provided on the same side surface of the container.

Preferably, the light source and the light reception unit are provided on different side surfaces of the container which are not faced to each other.

Preferably, the optical measurement analysis device further includes an input unit adapted to receive an input of information.

Preferably, the optical measurement analysis device further includes an output unit adapted to output a result of an analysis by the analyzing unit.

Preferably, the analyzing unit is adapted to store correction data for correcting a change of the optical spectrum according to a change of an environment in which the optical spectrum is determined.

Preferably, the optical measurement analysis device functions as a water-supply tank in an automatic ice maker in a refrigerator.

Preferably, the water-supply tank has a function of eliminating an impurity.

In accordance with another aspect, there is provided a storage room having a cooling function. The storage room includes any one of aforementioned the optical measurement analysis devices.

Preferably, the storage room is constituted by a refrigerator including an automatic ice maker. The optical measurement analysis device is provided in the automatic ice maker.

In accordance with further another aspect, there is provided an electromagnetic-wave generating device for supplying electromagnetic waves. The electromagnetic-wave generating device includes any one of aforementioned the optical measurement analysis devices.

In accordance with yet another aspect, there is provided an optical measurement analysis method utilizing an optical measurement analysis device. The optical measurement analysis method includes the steps of: housing a to-be-analyzed object; directing light from a light source into a container housing the to-be-analyzed object; receiving transmitted light having been transmitted through the to-be-analyzed object or reflected light having been reflected by the to-be-analyzed object; dispersing light received in the light receiving step into a spectrum; analyzing an optical spectrum obtained in the light-dispersion step; and reflecting the transmitted light or the reflected light by an inner wall of the container; applying the light directed in the directing step to the to-be-analyzed object for performing measurement on the to-be-analyzed object; and acquiring an optical spectrum from the light received in the light receiving step.

Preferably, the optical measurement analysis method further includes the step of detecting the weight of the to-be-analyzed object.

Preferably, the optical measurement analysis method further includes the step of receiving an input of information.

Preferably, the optical measurement analysis method further includes the step of outputting a result of an analysis in the analyzing step.

Preferably, the analyzing step further includes the step of storing correction data for correcting a change of the optical spectrum according to a change of an environment in which the optical spectrum is determined.

Preferably, the optical measurement analysis method further includes the step of eliminating an impurity.

In a certain aspect, it is possible to efficiently apply light to the entire surface of a to-be-analyzed object if possible and, further, it is possible to efficiently receive light reflected by or transmitted through the to-be-analyzed object, thereby performing analyses with improved accuracy.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a first example of an optical measurement analysis device, illustrating a first embodiment.

FIG. 2 is a view illustrating a second example of an optical measurement analysis device, illustrating the first embodiment.

FIG. 3 is a view illustrating a third example of an optical measurement analysis device, illustrating the first embodiment.

FIG. 4 is a view illustrating a fourth example of an optical measurement analysis device, illustrating the first embodiment.

FIG. 5 is a flow chart of an optical measurement analysis method, illustrating the first embodiment.

FIG. 6 is a view illustrating a refrigerator employing an optical measurement analysis device, illustrating a second embodiment.

FIG. 7 is a view illustrating a refrigerator employing an optical measurement analysis device, illustrating a third embodiment.

FIG. 8 is a view illustrating an electromagnetic-wave generating device employing an optical measurement analysis device, illustrating a fourth embodiment.

FIG. 9 is a view illustrating an optical measurement device, illustrating a conventional technique.

FIG. 10 is a view illustrating an object calorie-content measurement device, illustrating a conventional technique.

### DESCRIPTION OF THE PREFERRED EMBODIMENTS

Hereinafter, examples will be described with reference to the drawings. In the following description, the same components will be designated by the same reference characters and, further, have the same names and the same functions. Accordingly, these same portions will not be repeatedly described in detail.

### First Embodiment

### First Example

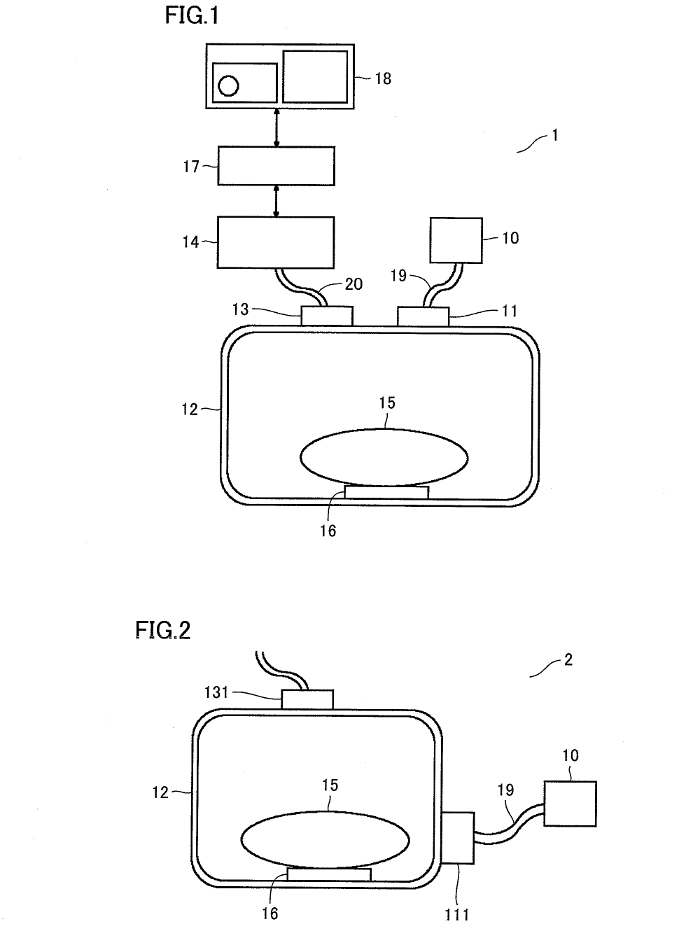

FIG. 1 illustrates a schematic view of a first example of an optical measurement analysis device according to the present embodiment.

An optical measurement analysis device 1 according to the present embodiment includes a light source 10, a container 12, a spectroscope unit 14, an analyzing unit 17, and an input/output unit 18. Container 12 is provided with a light-irradiation opening unit 11 as a light irradiation unit for injecting light into the container, and with a light-reception opening unit 13 as a light reception unit for directing light from the container to the outside thereof. Further, container 12 includes, inside thereof, a measurement table 16 for installing a test sample 15 thereon. Light source 10 and light-irradiation opening unit 11 are connected to each other through a light guide 19 adapted to direct light from light source 10 to light-irradiation opening unit 11. Further, light-reception opening unit 13 and spectroscope unit 14 are connected to each other through a light guide 20 adapted to direct light having passed through light-reception opening unit 13 to spectroscope unit 14. Spectroscope unit 14, analyzing unit 17 and input/output unit 18 are electrically connected to each other in such a way as to enable exchanging information therebetween.

Light source 10 according to the present embodiment is constituted by a halogen lamp which is capable of easily applying light over a wide wavelength range. However, light source 10 is not limited to such a halogen lamp and can be also constituted by any light source having a predetermined wavelength, such as a light emitting diode or a semiconductor laser, provided that light source 10 enables acquisition of necessary information about test sample 15. Light from light source 10 is passed through light guide 19, then is applied into container 12 through light-irradiation opening unit 11 and reaches test sample 15 or the inner wall of container 12.

Light guides 19 and 20 according to the present embodiment are constituted by respective optical fibers. However, light guides 19 and 20 are not limited to optical fibers and can be also constituted by any materials which are less prone to absorb light with wavelengths to be used for optical measurement analyses. Further, in order to stabilize the connection between light guide 19 and light-irradiation opening unit 11 and the connection between light guide 20 and light-reception opening unit 13, the respective connection portions are covered with protective members.

Light-irradiation opening unit 11 and light-reception opening unit 13 are formed to have sizes and shapes which enable most preferable irradiation and collection of light therethrough, in order to obtain information about test sample 15. Further, light-irradiation opening unit 11 and light-reception opening unit 13 are provided with respective optical windows between container 12 and light guides 19 and 20. This is for the sake of preventing the optical fibers employed as the light guides from being fractured at their end surfaces, due to impingement of the test sample and the like thereon. The optical windows according to the present embodiment are made of a silica glass. However, the optical windows are not limited to those made of such a silica glass and can be also made of any materials which are very prone to pass used light wavelengths therethrough.

Container 12 according to the present embodiment is constituted by a substantially-rectangular parallelepiped container. Due to the use of such a substantially-rectangular parallelepiped container, it is possible to stably install the container without employing a specific installation member. Also, container 12 can have other shapes, such as spherical shapes or cubic shapes. In a case where the container has a spherical shape, optical measurement analysis device 1 is enabled to efficiently collect, in the light-reception opening unit, components having been diffused and reflected by the inner wall of the container. Further, by employing an installation member, it is possible to stably install container 12 even when it has a spherical shape. Container 12 is desirably formed to have a size and a shape which are determined according to the size and the shape of test sample 15, in such a way as to enable most preferable irradiation and collection of light, in order to obtain information about test sample 15.

Container 12 is coated with barium sulfate, on its inner wall, in order to increase its reflectivity for light having been injected into the container and reached the inner wall thereof, and in order to realize higher diffusibility thereof. However, the inner wall of container 12 is not limited thereto and can be also formed from any materials having a higher reflectivity and excellent diffusibility. The inner wall having such a higher reflectivity for wavelengths of incident light is capable of preventing attenuation due to reflections.

The present embodiment has been described with respect to a case where there is provided measurement table 16 with a disk shape which is made of an urethane and has a diameter of 8 cm and a height of 3 cm, within container 12 with a width of 30 cm, a depth of 25 cm and a height of 25 cm, in order to perform measurement on meat. However, the container can be changed in size, according to the size of the test sample.

Measurement table 16 has such a height as to allow light to go around test sample 15 to reach the lower surface of test sample 15. Further, measurement table 16 is formed such that its test-sample placing surface has an area smaller than that of test sample 15 to cause test sample 15 to protrude from measurement table 16. Due to such a shape of measurement table 16, light applied thereto can easily go around the entire surface of test sample 15. Measurement table 16 is not limited to one having such a disk shape, provided that measurement table 16 enables preferably performing necessary analyses. Further, measurement table 16 can be made of any material which enables stably placing the test sample thereon.

Test sample 15 is surrounded by container 12. Container 12 is constituted by the inner wall having a high reflectivity and excellent diffusibility and, further, is designed to have such a size and a shape as to enable efficiently obtaining light being reflected or diffused after having been applied to the entire surface of test sample 15.

Accordingly, light applied into container 12 is caused to go around substantially the entire surface of test sample 15 except its portion contacting with measurement table 16 and, thus, is applied to test sample 15 in various directions. Further, light reflected in various directions by test sample 15 and light passed through test sample 15 are reflected by the inner wall of container 12 and reach light-reception opening unit 13. Accordingly, optical measurement analysis device 1 can easily and efficiently receive diffused/reflected components of light as well as regularly-reflected components of light for determining an optical spectrum thereof and, therefore, can analyze information obtained from substantially the entire surface of test sample 15.

Further, measurement table 16 is not an essential structure for optical measurement analysis device 1, for the following reason. Depending on the shape of the test sample, even when there is not provided measurement table 16, light reflected by the inner wall of container 12 can be applied to the surface of test sample 15 over a wider range thereof, and light reflected thereby or passed therethrough can reach light-reception opening unit 13.

Light-irradiation opening unit 11 and light-reception opening unit 13 are provided proximally to each other on the same side surface of container 12. Light which reaches light-reception opening unit 13 includes light which directly reaches light-reception opening unit 13 by being reflected by test sample 15 and, further, includes light which reaches light-reception opening unit 13 by being reflected by test sample 15 or passed through test sample 15 and further being reflected by the inner wall of container 12. Since the two opening units for light irradiation and light reception are provided proximally to each other on the same surface, it is possible to inhibit light injected through light-irradiation opening unit 11 from directly entering light-reception opening unit 13. Accordingly, optical measurement analysis device 1 is capable of reducing noise in optical analyses and, also, is capable of reducing backgrounds, thereby enabling optical measurement analyses with higher accuracy.

Spectroscope unit 14 is a device which is adapted to perform wavelength resolution on light having reached light-reception opening unit 13 and to determine the light intensity of each wavelength for acquiring data of optical spectra. Spectroscope unit 14 is constituted by a multi-channel spectrometer. However, spectroscope unit 14 is not limited thereto and can be also constituted by a diffraction-grating-type spectrometer or a CCD (Charge Coupled Device Image Sensor) camera. Data of optical spectra which has been obtained by spectroscope unit 14 is outputted to analyzing unit 17.

Analyzing unit 17 is a device which is adapted to perform analysis processing on data of optical spectra which has been obtained by spectroscope unit 14, using programs which have been preliminarily stored in analyzing unit 17 and a database which has been stored therein, in order to obtain information about test sample 15. Analyzing unit 17 is constituted by a microcomputer which include a CPU (Central Processing Unit), a microcontroller, a hardware circuit, or a combination of them. Analyzing unit 17 is capable of obtaining information about test sample 15, regarding the type, the components contained therein, the quality, the degree of freshness, the frozen state, the degree of contaminations by molds or microorganisms, impurities or foreign substances mixed therein.

Input/output unit 18 is electrically connected to analyzing unit 17. Input/output unit 18 is a portion which enables inputting and outputting information necessary for optical measurement analyses, management of the optical measurement analysis device and the like, wherein input/output unit 18 is provided outside container 12. Input/output unit 18 employs a system for enabling a user to generate commands through manipulations of a panel therein, and can be installed at an arbitrary position at which input/output unit 18 does not inhibit operations of the measurement analysis device. The user of optical measurement analysis device 1 is enabled to perform both inputting and outputting through the single panel and, therefore, is enabled to easily control optical measurement analysis device 1. However, input/output unit 18 is not limited to such a structure for enabling both inputting and outputting, and also can be provided with an input unit and an output unit separately. Further, input/output unit 18 is not necessarily required to include both an input unit and an output unit.

Optical measurement analysis device 1 according to the present embodiment is capable of analyzing information obtained from substantially the entire surface of test sample 15 at the same time and, therefore, is capable of attaining analyses in a shorter time period. Further, even when test sample 15 has a non-uniform concentration distribution or a non-uniform component distribution, and even when test sample 15 contains impurities or contaminations at preliminarily-unknown portions, optical measurement analysis device 1 can obtain results of analyses with higher accuracy. Further, there is no need for irradiation of light with extremely-high intensity and, therefore, optical measurement analysis device 1 can alleviate influences of heat on the test sample. Further, there is no need for providing a driving system for rotating the test sample and the like and, therefore, optical measurement analysis device 1 is not required to include a space and parts for forming such a driving system and, further, is not required to consume electric power therefor. This can simplify the device.

Further, in the present embodiment, optical measurement analysis device 1 can be also structured to determine the weight of test sample 15 with a weight sensor provided in measurement table 16, provided that optical measurement analysis device 1 does not inhibit light from going therearound. In this case, analyzing unit 17 is enabled to perform analyses in consideration of the weight of test sample 15, which can improve the analysis accuracy of analyzing unit 17.

Further, in the present embodiment, spectroscope unit 14 is adapted to perform wavelength resolution and to determine light intensity of each wavelength for acquiring optical spectra. However, optical measurement analysis device 1 can be also structured to disperse light into spectra in the light-irradiation side, by providing light source 10 with a device capable of wavelength resolution, such as a wavelength-variable filter or an acousto-optic tunable filter and, further, by employing a light-reception device such as a photo diode, instead of spectroscope unit 14.

### Second Example

FIG. 2 illustrates a second example of an optical measurement analysis device according to the present embodiment. An optical measurement analysis device 2 is different from optical measurement analysis device 1, in that a light-irradiation opening unit 111 as a light irradiation unit and a light-reception opening unit 131 as a light reception unit are provided on different side surfaces, rather than on the same side surface, but the other portions are the same thereas. Light-irradiation opening unit 111 can be also installed on a side surface of a test sample 15. Depending on the shape of test sample 15, light which is applied to test sample 15 can easily go around the entire surface thereof, which facilitates acquisition of light from substantially the entire surface of test sample 15.

Further, referring to FIG. 2, light-irradiation opening unit 111 and light-reception opening unit 131 are installed such that the line connecting light-irradiation opening unit 111 and test sample 15 to each other is intersected with the line connecting light-reception opening unit 131 and test sample 15 to each other at an angle of 90 degrees therebetween. However, the installation of them is not limited thereto. It is necessary only that light-irradiation opening unit 111 and light-reception opening unit 131 are not installed at positions opposing to each other.

### Third Example

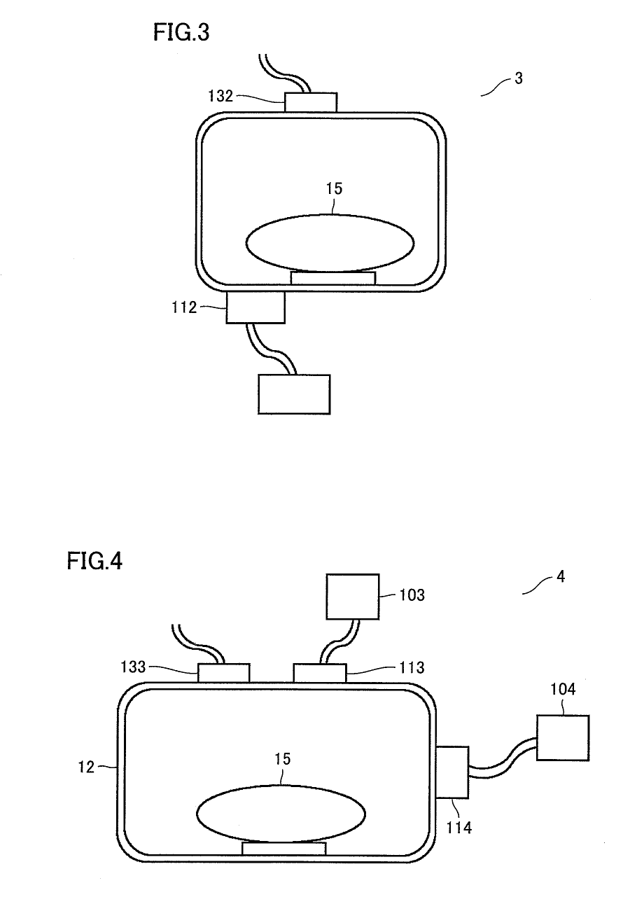

FIG. 3 illustrates a third example of an optical measurement device according to the present embodiment. An optical measurement analysis device 3 is different from optical measurement analysis device 1, in that a light-irradiation opening unit 112 as a light irradiation unit and a light-reception opening unit 132 as a light reception unit are installed on opposing surfaces of a container. In this case, optical measurement analysis device 3 can easily detect light passed through a test sample 15 and, therefore, is mainly employed for performing measurement on test samples which can be analyzed with higher accuracy based on light transmitted therethrough. Further, light emitted through the light-irradiation opening unit can not entirely pass through test sample 15 and, therefore, optical measurement analysis device 3 can also perform optical measurement analyses using reflected light.

### Fourth Example

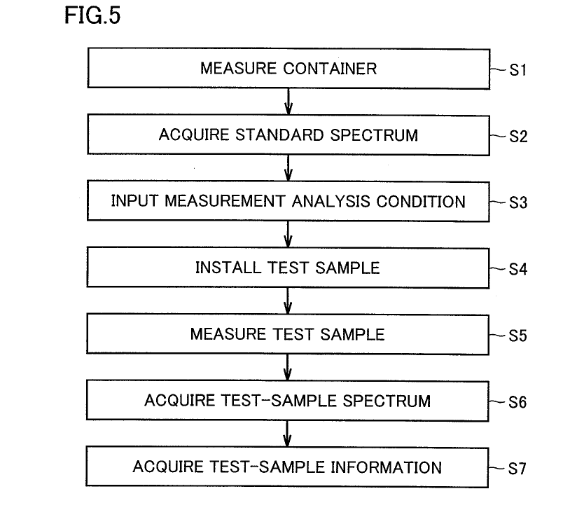

FIG. 4 illustrates a fourth example of an optical measurement analysis device according to the present embodiment. An optical measurement analysis device 4 is different from optical measurement analysis device 1, in that optical measurement analysis device 1 includes a plurality of light-irradiation opening units as light irradiation units.

Optical measurement analysis device 4 includes a plurality of light-irradiation opening units 113 and 114 which are provided on a container 12 and is structured to enable a person who performs measurement to arbitrarily change over, therebetween, a to-be-used light-irradiation opening unit, according to the shape of a test sample 15. Light is received through a light-reception opening unit 133 as a light-reception unit. Irradiation can be performed either through any one of the light-irradiation opening units or through both the light-irradiation opening units. In FIG. 4, there are provided light sources 103 and 104 for the respective light-irradiation opening units. However, a branched light guide can be connected to the respective light-irradiation opening units, and a single light source can be connected to this light guide.

With the aforementioned structure, regardless of the shape of test sample 15, light which is applied to test sample 15 can easily go around the entire surface thereof, which facilitates acquisition of light from substantially the entire surface of test sample 15.

FIG. 5 illustrates a flow chart of an optical measurement analysis method according to the present embodiment. Hereinafter, there will be described a case where an analysis of a test sample is conducted.

At first, step S1 of performing measurement on the container is performed, in a state where no test sample is housed therein. Based on the result of the measurement, step S2 of acquiring a standard spectrum is performed. The standard spectrum is a spectrum which is obtained by applying light from the light source into the container, further receiving light reflected by the inner wall thereof and dispersing the light into a spectrum with the spectroscope unit, in a state where no test sample is housed in the container. The standard spectrum is stored in the analyzing unit. Further, programs for acquiring optical spectra have been preliminarily stored in the analyzing unit. A command for determining such a standard spectrum is outputted by manipulating the panel provided as the input/output unit.

When the completion of the determination of the standard spectrum has been indicated by the input/output unit, step S3 of inputting measurement analysis conditions is performed. Step S3 is for inputting information necessary for analyses, such as the name of the test sample, measurement conditions. However, step S3 is not necessarily an essential step.

Next, the test sample is placed on the measurement table in the optical measurement analysis device for performing step S4 of installing the test sample. The user commands the optical measurement analysis device to perform analyses of the test sample, by manipulating the panel in the input/output unit. Although step S4 is performed manually in the present embodiment, an automatic program or mechanism can be also employed for taking in and out the test sample and for conducting measurement.

On receiving the command, the optical measurement analysis device performs step S5 of applying light to the test sample as a to-be-analyzed object through the light-irradiation opening unit and for performing measurement on the test sample. A portion of the light from the light source is directly applied to the test sample, but the other portion of the light is repeatedly reflected by the inner wall of the container which has higher diffusibility and reflectivity and, further, is applied to the test sample. Light reflected by the test sample and light passed through the test sample reach the light-reception opening unit, directly or after being repeatedly reflected by the inner wall of the container. The light is directed to the spectroscope unit through the light guide. Further, the spectroscope unit performs step S6 of acquiring a test-sample spectrum.

The analyzing unit performs step S7 of performing calculation processing on the test-sample spectrum using the acquired standard spectrum and, further, analyzing the calculated optical spectrum for acquiring information about the test sample.

In the present embodiment, the optical measurement analysis device calculates an absorption spectrum of the test sample using the standard spectrum and, further, acquires information about the types and the concentrations of components contained in the test sample, and the amount of impurities or contaminations therein.

An absorption spectrum indicates intensity of light absorbed by a substance, that is so-called absorbance which varies with the wavelength. Such an absorption spectrum is calculated using data of a standard spectrum and a calculation formula utilizing the Lambert-Beer law. The optical measurement analysis device can acquire information about the types and the amounts of components contained in the test sample, by analyzing the intensity and the wavelengths of light absorbed by the test sample.

Further, the optical measurement analysis device can also use the standard spectrum for calculating a reflectivity spectrum and, therefore, can be also adapted to a case where it is desired to determine reflection spectra, as well as absorption spectra. Further, the optical measurement analysis device can also use the standard spectrum for subtracting, from optical spectra, influences of unnecessary external factors for the test sample on measured values, wherein such unnecessary external factors include water vapor within the container, light incident from the outside of the container, and the like.

In the present embodiment, the analyzing unit is adapted to perform regression analyses utilizing multivariate analyses, which are frequently utilized in fields of nondestructive measurements. More specifically, the optical measurement analysis device is adapted to preliminarily determine an absorption spectrum of an object having known properties, further to preliminarily derive a correlation between the properties of the object and the absorption spectrum, as a model, and to preliminarily store it in the analyzing unit. Further, the analyzing unit analyzes an optical spectrum obtained from an unknown to-be-analyzed object, using this model, for acquiring information about properties of this to-be-analyzed object, in a regression manner. The analyzing method is not limited to such regression analyses and can be also other methods such as principal component analyses or exploratory data analyses.

Further, in the present embodiment, the optical measurement analysis device is adapted to perform analyses using a standard spectrum and determined spectra. However, the optical measurement analysis device can also utilize correction data for improving the accuracy of analyses.

For example, in a case where the test sample contains a larger amount of moisture like a crop, an absorption spectrum obtained from measurement on the test sample largely contains an absorption spectrum of the moisture contained in the test sample. Particularly, in a case where the irradiation light has wavelengths in the near-infrared range or in the infrared range, the shape of the absorption spectrum of the moisture occupies the overall absorption spectrum of the test sample, by a large amount which exerts an un-negligible influence thereon.

Such an absorption spectrum of moisture is changed in shape, depending on the temperature and the humidity. Accordingly, the absorption spectrum of the test sample is also largely influenced by the temperature and the humidity. Thus, in a case where components other than moisture are most desired to be measured, even when the amounts of the components desired to be measured are not changed, the shape of the absorption spectrum is changed depending on the temperature and the humidity, which exerts influences on the results of analyses, thereby inducing errors therein.

In order to eliminate such influences, correction data is utilized. By preliminarily storing such correction data in the optical measurement analysis device, the optical measurement analysis device is enabled to perform corrections of optical spectra and corrections of numerical values resulted from analyses, by reading the correction data therefrom as required.

Concrete correction methods are varied depending on the types of analyses. For example, when the optical measurement analysis device performs measurement on samples containing larger amounts of moisture, the optical measurement analysis device is caused to preliminarily determine respective spectra of moisture for different temperature values and humidity values in the optical measurement analysis device and, further, is caused to preliminarily store, therein, these spectra of moisture as correction data, along with the numerical values of the temperature and the humidity, as a data base. This data base can be also stored in the optical measurement analysis device, before the shipment of the product. By storing the data base in the optical measurement analysis device before the shipment thereof, it is possible to reduce the burden on the user. The analyzing unit is enabled to subtract, from a determined spectrum, the spectrum of moisture which is associated with the temperature and the humidity at the time of the measurement, thereby eliminating the influence of moisture on the spectrum. In this case, it is necessary to provide sensors for determining the temperature and the humidity in the optical measurement analysis device and, further, it is necessary to perform processing for determining the temperature and the humidity at the time of measurement of the test sample.

Also, it is possible to preliminarily derive data of correction terms to be added to a calculation model or a calculation formula for use in analyses, and it is possible to preliminarily store the data of the correction terms in the analyzing unit for enabling the analyzing unit to use these correction terms as required. By using this method, similarly, the optical measurement analysis device can perform analyses with higher accuracy.

### Second Embodiment

In the present embodiment, an optical measurement analysis device according to the present embodiment is used in a refrigerator.

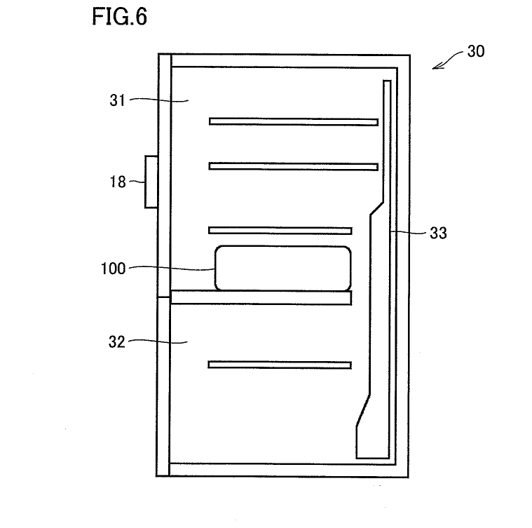

FIG. 6 is a cross-sectional view of a refrigerator 30 employing an optical measurement analysis device 100 according to the present embodiment. Optical measurement analysis device 100 is capable of performing measurement and analyses, with food stuffs stored in refrigerator 30 being kept cooled or frozen. The user is not required to put the food stuffs into a room temperature during measurement, which can prevent degradations of the food stuffs. Optical measurement analysis device 100 is installed inside a refrigerating room 31 in refrigerator 30, as a dedicated measurement room constituted by an isolated room. Optical measurement analysis device 100 includes a dehumidification device, which is not illustrated. Refrigerating room 31 is provided at an upper portion of refrigerator 30, and a freezing room 32 is provided at a lower portion therein, wherein refrigerating room 31 and freezing room 32 are separated from each other through a heat insulation material or a heat insulation wall. A cooling mechanism unit 33 is provided on the rear surfaces of refrigerating room 31 and freezing room 32. In refrigerating room 31, it is also possible to provide a plurality of placement shelves for housing to-be-stored objects thereon, a chilled room constituted by an isolated room, a vegetable room, a small-object housing room, a water-supply tank and the like. Further, in freezing room 32, it is also possible to provide an icebox, a small-object housing room, and the like.

Hereinafter, there will be described a method for using optical measurement analysis device 100 inside refrigerator 30. At first, a user acquires a standard spectrum in a state where nothing is housed in optical measurement analysis device 100. The user generates a command for determining such a standard spectrum, through an input/output unit 18. Input/output unit 18 is a panel provided at an outer portion of the refrigerator, and the user generates commands to optical measurement analysis device 100, by manipulating the panel. After the completion of the determination of the standard spectrum is indicated by input/output unit 18, the user places a food stuff desired to be measured, on a measurement table within optical measurement analysis device 100, then closes the door of refrigerator 30 and, further, commands optical measurement analysis device 100 to perform analyses of the food stuff, through input/output unit 18. On receiving the command, optical measurement analysis device 100 operates a fan and a drying mechanism which are included in the dehumidification device, for eliminating moisture and cooled air therefrom. Thereafter, optical measurement analysis device 100 applies light to the food stuff as a to-be-analyzed object, through a light-irradiation opening unit. Optical measurement analysis device 100 performs analyses on spectra of light having been reflected by the food stuff and reached a light-reception opening unit and light having been reflected by the food stuff or passed through the food stuff and, further, been reflected by the inner wall of optical measurement analysis device 100 and reached the light-reception opening unit. In the present example, optical measurement analysis device 100 performs analyses on an absorption spectrum resulted from irradiation of light with wavelengths in the near-infrared range, through a method utilizing a calibration curve according to a multivariate analysis methodology, in order to acquire information about the sugar content of the food stuff. Optical measurement analysis device 100 is also capable of acquiring information about the food stuff, regarding nutrients, minerals, the degree of freshness, residual agricultural chemicals, caffeine and the calorie content, in addition to the sugar content. Further, it is desirable that an analyzing unit has preliminarily stored a data base containing information about calibration curves and optical spectra in association with types and components of food stuffs, for use in analyses.

Optical measurement analysis device 100 is capable of performing measurement and analyses, with food stuffs stored in the refrigerator being kept cooled and frozen. This eliminates the necessity of putting the food stuffs into a room temperature during the measurement, which can prevent degradations of the food stuffs. Further, in general, inside the refrigerator, there are less variations in temperature and humidity, in comparison with the outside thereof, which can stabilize optical spectra therein. Therefore, optical measurement analysis device 100 also has the advantage of reducing analysis errors.

In the present embodiment, there has been described a case where optical measurement analysis device 100 is provided inside refrigerating room 31. However, optical measurement analysis device 100 can be also provided within freezing room 32, provided that optical measurement analysis device 100 is enabled to perform desired analyses.

Further, in the present embodiment, optical measurement analysis device 100 is provided in refrigerator 30. However, optical measurement analysis device 100 is not necessarily required to be provided in such a refrigerator having both freezing and refrigerating functions, and can be also provided in a storage room having a cooling function for freezing or refrigerating.

### Third Embodiment

According to the present embodiment, there is provided an another example of a refrigerator employing an optical measurement analysis device according to the present embodiment.

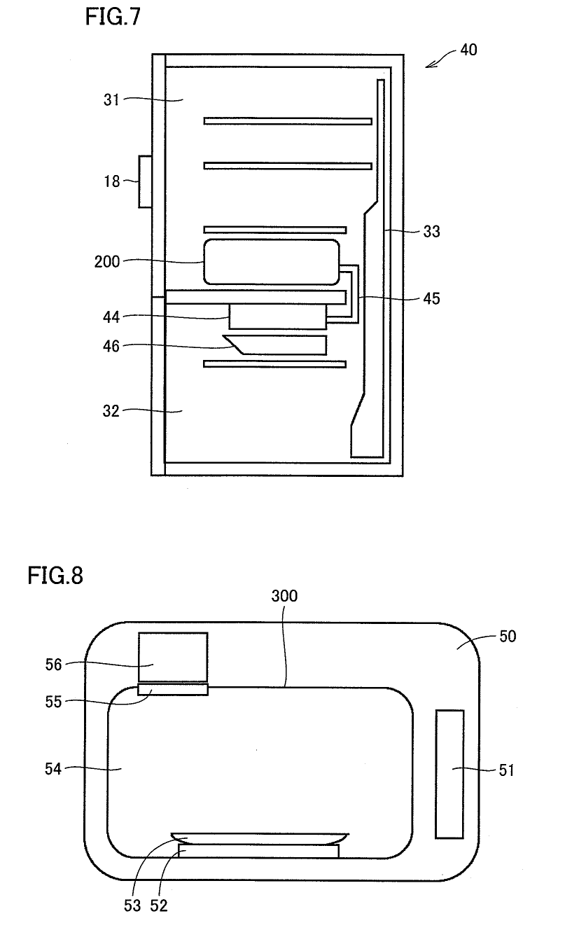

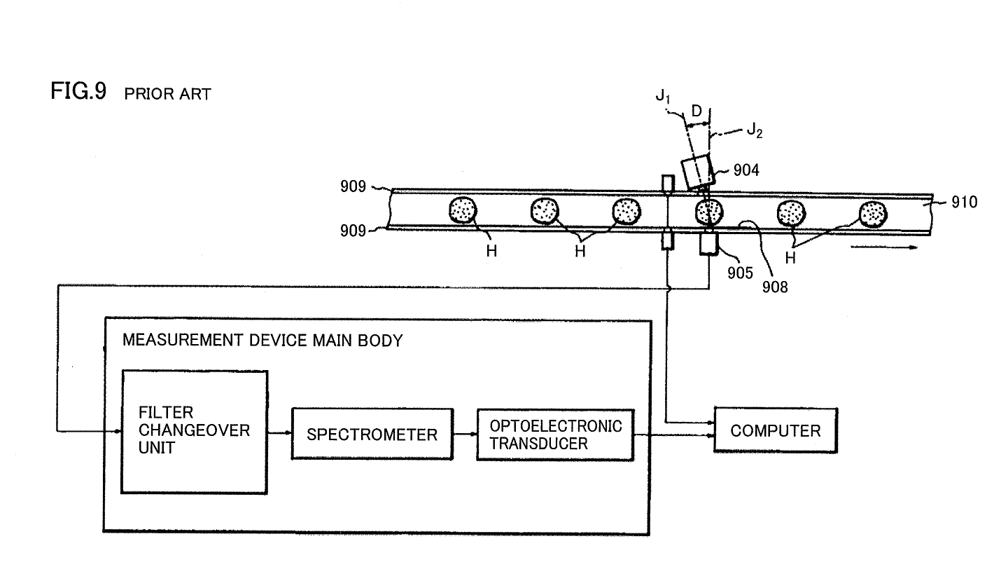

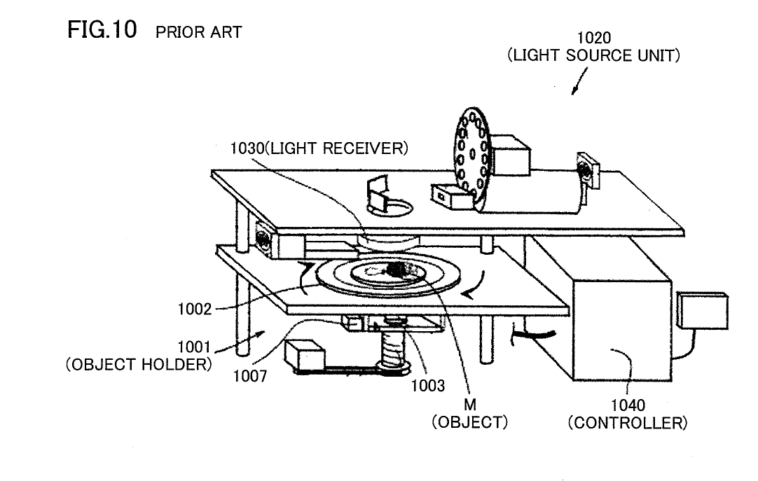

FIG. 7 is a cross-sectional view of a refrigerator 40 employing an optical measurement analysis device 200 according to the present embodiment. Optical measurement analysis device 200 has the function of performing optical measurement and analyses and, further, performs the function of a water-supply tank in an automatic ice maker in refrigerator 40. Optical measurement analysis device 200 includes a dehumidification device and a filter, which are not illustrated. In the present embodiment, optical measurement analysis device 200 is adapted to perform analyses as to whether or not there exist microorganisms, molds and the like, within a container which also serves as a water-supply tank. Accordingly, there is not provided a measurement table, inside the container. Inside refrigerator 40, microorganisms, molds and the like are very prone to occur within the water-supply tank. Therefore, such contaminations can be found in early stages. In a freezing room 32, there are provided an ice tray 44 and an ice box 45 in the automatic ice maker. Further, there will not be repeatedly described, in detail, the structures designated by the same reference characters as the reference characters for the structures according to the second embodiment.

Hereinafter, there will be described operations of optical measurement analysis device 200 according to the present embodiment. At first, optical measurement analysis device 200 as the water-supply tank will be described. When water has been set in optical measurement analysis device 200, a certain amount of water is automatically flowed into ice tray 44 through a water-supply pump 45. Thereafter, on detecting ice having been created therein, optical measurement analysis device 200 discharges the ice into ice box 46 stored in an area in freezing room 32. Optical measurement analysis device 200 repeats this series of operations, until the water in optical measurement analysis device 200 has run out.

Next, optical measurement analysis device 200 as the optical measurement analysis device will be described. When the water in the water-supply tank has run out, optical measurement analysis device 200 operates a fan and a drying mechanism which are included in the dehumidification device, thereby eliminating moisture and cooled air therefrom. Next, optical measurement analysis device 200 applies light into the empty container through a light-irradiation opening unit, further performs an analysis on a spectrum of light having been reflected by the inner wall thereof and reached a light-reception opening unit to acquire information about molds, microorganisms and the like therein.

Further, an analyzing unit has preliminarily stored a database containing information about a standard spectrum, and various optical spectra and models which are relating to states of molds, microorganisms and the like inside the optical measurement analysis device, and this database is used for analyses.

To-be-analyzed-and-measured objects are contaminations within the container, rather than test samples. Therefore, the standard spectrum is an optical spectrum which has been determined, from the inside of the container, in a state where refrigerator 40 is not used and, therefore, is clean. Accordingly, by storing such a standard spectrum in the data base before the shipment of refrigerator 40 from the factory, it is possible to save the user from labor for determination of the standard spectrum.

Information obtained by optical measurement analysis device 200 is displayed on an input/output unit 18 as required, thereby causing the user to be notified thereof. In this case, input/output unit 18 is a panel provided on an outer portion of refrigerator 40.

Further, in the present embodiment, optical measurement analysis device 200 includes the dehumidification device. In a case where optical measurement analysis device 200 is coated, on its inner wall, with barium sulfate as a reflective material, the reflectivity of the inner wall is influenced by moisture. Further, light diffusion is influenced by cold air and condensation. Accordingly, by eliminating moisture, cold air, condensation and the like as much as possible by the dehumidification device, optical measurement analysis device 200 is enabled to obtain results of more accurate analyses.

Further, in the present embodiment, in order to eliminate impurities in water, a filter is installed in optical measurement analysis device 200. The types of eliminated impurities can be preferably determined, through the material of the filter. Such a filter is capable of preventing the inner wall member of optical measurement analysis device 200 and the reflective material provided as a coating on the inner wall from being mixed into water and, therefore, it is desirable to install such a filter. Particularly, in a case where the coating material is made of the barium sulfate, the barium sulfate can be efficiently eliminated by the filter, since barium sulfate is insoluble in water. Further, it is also possible to employ any other water-purification mechanisms capable of eliminating impurities in water, instead of such a filter. Further, optical measurement analysis device 200 can be also provided in the ice tray or the ice box for detecting molds and microorganisms, instead of being provided as the water-supply tank. However, molds and microorganisms most likely occur in the water-supply tank and, therefore, it is desirable to provide optical measurement analysis device 200 as a water-supply tank for performing measurement and analyses on the interior of the tank, which can facilitate detection of molds and microorganisms.

Further, optical measurement analysis device 200 desirably includes both the dehumidification device and the filter. Optical measurement analysis device 200 is not necessarily required to include both of them.

As described above, with the optical measurement analysis device according to the present embodiment, it is possible to detect molds and microorganisms, which may occur in the automatic ice maker to induce problems therein.

### Fourth Embodiment

According to the present embodiment, there is provided an example where an optical measurement analysis device is applied to an electromagnetic-wave generating device for supplying electromagnetic waves.

FIG. 8 is a cross-sectional view of an electromagnetic-wave generating device 50 employing an optical measurement analysis device according to the present embodiment. An optical measurement analysis device 300 is capable of performing measurement and analyses on food stuffs placed in a housing room 54. Housing room 54 in electromagnetic-wave generating device 50 performs the functions of a container within optical measurement analysis device 300.

Electromagnetic-wave generating device 50 includes housing room 54 and, further, includes a door for opening and closing housing room 54, a table 52 for placing a test sample thereon within housing room 54, and a tray 53 placed on table 52. An electromagnetic-wave generator 56 generates electromagnetic waves, which are supplied through a supply port 55. Housing room 54 in electromagnetic-wave generating device 50 is provided with an electromagnetic-wave shield member constituted by a perforated metal plate and a metal mesh for intercepting electromagnetic waves and, further, housing room 54 also functions as a microwave oven. Housing room 54 is coated with barium sulfate, on its inner wall. Due to this coating, the optical measurement analysis device can have a higher reflectivity and higher diffusibility and, therefore, the optical measurement analysis device is capable of exerting its functions with higher accuracy. A controller 51 has various types of well-known functions of controlling electromagnetic-wave generator 56. Here, table 52 and tray 53 are not necessarily required to be installed in housing room 52.

Next, there will be described a method for using electromagnetic-wave generating device 50 according to the present embodiment. In the present embodiment, the user introduces a meat into housing room 54 and performs optical measurement and analyses thereon and, thereafter, performs heating thereof through electromagnetic waves.

The degree of deterioration of the food stuff is determined through optical analyses and measurement, and the result thereof is displayed on a display unit provided on an outer side of electromagnetic-wave generating device 50.

The degree of deterioration of the food stuff can be determined, based on increases and decreases of components contained in the food stuff, changes in types of components therein, occurrence of molds and microorganisms therein. In the present embodiment, optical measurement analysis device 300 has preliminarily stored data as a determination standard based on nutrient compositions in meat, such as amounts of proteins and fatty acids therein.

Thereafter, the meat is heated by electromagnetic waves. Before the heating, such optical measurement analyses are performed, which enables grasping the safety of the meat more certainly.

Also, optical measurement analysis device 300 can be installed within the electromagnetic-wave generator, as a dedicated measurement room constituted by an isolated room.

Although preferred embodiments of the present invention have been described, the present invention is not necessarily limited to the aforementioned embodiments, and various changes can be made thereto without departing from the spirit of the present invention. For example, the optical measurement analysis device can be also used with containers which enable applying light to the inside thereof for analyses, such as white-goods household electric appliances other than refrigerators, containers for housing clothes and art objects, water purifiers.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An optical measurement analysis device comprising:
a container capable of housing a to-be-analyzed object;
a light source;
a light irradiation unit adapted to direct light from said light source into said container;
a light reception unit adapted to receive transmitted light having been transmitted through said to-be-analyzed object or reflected light having been reflected by said to-be-analyzed object;
a spectroscope unit adapted to disperse light received by said light reception unit into a spectrum; and
an analyzing unit adapted to analyze an optical spectrum obtained by said spectroscope unit,
wherein said container has an inner wall adapted to reflect said transmitted light or said reflected light.

2. The optical measurement analysis device according to claim 1, further comprising a measurement table for placing said to-be-analyzed object thereon,
wherein said measurement table is adapted to have an area smaller than that of said to-be-analyzed object.

3. The optical measurement analysis device according to claim 2, wherein said measurement table includes a sensor for detecting the weight of said to-be-analyzed object.

4. The optical measurement analysis device according to claim 1, wherein said light source and said light reception unit are provided on the same side surface of said container.

5. The optical measurement analysis device according to claim 1, wherein said light source and said light reception unit are provided on different side surfaces of said container which are not faced to each other.

6. The optical measurement analysis device according to claim 1, further comprising an input unit adapted to receive an input of information.

7. The optical measurement analysis device according to claim 1, further comprising an output unit adapted to output a result of an analysis by said analyzing unit.

8. The optical measurement analysis device according to claim 1, wherein said analyzing unit is adapted to store correction data for correcting a change of said optical spectrum according to a change of an environment in which said optical spectrum is determined.

9. The optical measurement analysis device according to claim 1, wherein said optical measurement analysis device functions as a water-supply tank in an automatic ice maker in a refrigerator.

10. The optical measurement analysis device according to claim 9, wherein said water-supply tank has a function of eliminating an impurity.

11. A storage room having a cooling function, wherein said storage room includes the optical measurement analysis device according to claim 1.

12. The storage room according to claim 11, wherein said storage room comprises a refrigerator including an automatic ice maker, and
said optical measurement analysis device is provided in the automatic ice maker.

13. An electromagnetic-wave generating device for supplying an electromagnetic wave:
wherein said electromagnetic-wave generating device includes the optical measurement analysis device according to claim 1.

14. An optical measurement analysis method utilizing an optical measurement analysis device comprising the steps of:
housing a to-be-analyzed object;
directing light from a light source into a container housing said to-be-analyzed object;
receiving transmitted light having been transmitted through said to-be-analyzed object or reflected light having been reflected by said to-be-analyzed object;
dispersing light received in said light-receiving step into a spectrum;
analyzing an optical spectrum obtained in said light-dispersion step;
reflecting said transmitted light or said reflected light by an inner wall of said container;
applying the light directed in said directing step to said to-be-analyzed object for performing measurement on said to-be-analyzed object; and
acquiring an optical spectrum from the light received in said light receiving step.

15. The optical measurement analysis method according to claim 14, further comprising the step of detecting the weight of said to-be-analyzed object.

16. The optical measurement analysis method according to claim 14, further comprising the step of receiving an input of information.

17. The optical measurement analysis method according to claim 14, further comprising the step of outputting a result of an analysis in said analyzing step.

18. The optical measurement analysis method according to claim 14, wherein said analyzing step further includes the step of storing correction data for correcting a change of said optical spectrum according to a change of an environment in which said optical spectrum is determined.

19. The optical measurement analysis method according to claim 14, further comprising the step of eliminating an impurity.
